(19) United States
(12) Patent Application Publication
(10) Pub. No.: US 2026/0187279 A1
(43) Pub. Date: Jul. 2, 2026

(54) PRIVACY-PRESERVING ESTIMATION OF AGGREGATED METRICS

(71) Applicant: Google LLC, Mountain View, CA (US)

(72) Inventors: Adam Benjamin Gelernter Sealfon, New York, NY (US); Pasin Manurangsi, Bangkok (TH); Badih Ghazi, Cupertino, CA (US); Shanmugasundaram Ravikumar, Piedmont, CA (US); Pritish Kamath, Mountain View, CA (US); Jiayu Peng, Sunnyvale, CA (US)

(21) Appl. No.: 18/859,125

(22) PCT Filed: Jul. 5, 2024
(86) PCT No.: PCT/US2024/036928

§ 371 Date: Oct. 22, 2024

Related U.S. Application Data
(60) Provisional application No. 63/525,385, filed on Jul. 7, 2023.

(51) Int. Cl. G06F 21/62

(52) U.S. Cl. CPC G06F 21/6254

(57) ABSTRACT

Methods, systems, and apparatus, including computer programs encoded on a computer storage medium, for estimating a privacy-persevering aggregated metric characterizing the set of entities. A computer-implemented system obtains input data specifying, for each of the set of entities, an entity-specific quantity of the respective entity. The system defines a series of ascending values representing possible values for the entity-specific quantities of the set of entities. The system repeatedly performing operations for (i) updating the threshold value and (ii) updating an estimated value for the aggregated metric depending on the updated threshold value and a privacy budget until (i) the threshold value reaches a maximum threshold value or (ii) a stopping condition is met.

### CROSS-REFERENCE TO RELATED APPLICATION

This application claims priority to U.S. Provisional Patent Application No. 63/525,385, filed on Jul. 7, 2023, the disclosure of which is hereby incorporated by reference in its entirety.

### TECHNICAL FIELD

This specification generally relates to privacy-preserving data processing.

### BACKGROUND

Differential privacy is a family of privacy techniques that can be applied in various processes to protect privacy of individual entities. To apply differential privacy, noise is typically added to the computations or queries performed on a dataset. The noise introduces randomness and obscures the contribution of specific individuals in the data.

### SUMMARY

This specification describes methods, computer systems, and apparatus, including computer programs encoded on computer storage media, for estimating, in a privacy-preserving manner, an aggregated metric characterizing a set of entities.

In one aspect, this specification describes a method for estimating a privacy-persevering aggregated metric characterizing the set of entities. The method can be implemented by a system including one or more computers. The system obtains input data specifying, for each of the set of entities, an entity-specific quantity of the respective entity. The system further defines a series of ascending values representing possible values for the entity-specific quantities of the set of entities. The system initializes a threshold value to a first value in the series of ascending values. The system repeatedly performing operations for (i) updating the threshold value and (ii) updating an estimated value for the aggregated metric depending on the updated threshold value and a privacy budget until (i) the threshold value reaches a maximum threshold value or (ii) a stopping condition is met. The operations include updating the threshold value to a next value in the series of ascending values, determining a current cumulative count based on a number of entity-specific quantities equal or greater than the threshold value, determining the estimated value for the aggregated metric based at least on (i) the current cumulative count and (ii) a first noise value generated based the privacy budget, and determining whether the stopping condition is met based at least on the current cumulative count. The system outputs the estimated value for the aggregated metric.

In some implementations, to determine whether the stopping condition is met, the system compares the current cumulative count to a predefined threshold count, and in response to the current cumulative count being below the predefined threshold count, determines that the stopping condition is met.

In some other implementations, to determine whether the stopping condition is met, the system computes a sum of the current cumulative count and one or more preceding cumulative counts, wherein each preceding cumulative count is determined based on the number of entity quantities that are equal or greater than a value preceding the threshold value in the series of ascending values, compares the sum to a predefined threshold count, and in response to the sum being below the predefined threshold count, determines that the stopping condition is met.

In some implementations, to determine the estimated value for the aggregated metric, the system determines a first estimated value based at least on (i) the current cumulative count and (ii) the first noise value generated based on the privacy budget, determines a first variance for the first estimated value, determines a second estimated value based at least on (i) the updated threshold value and (ii) a second noise value generated based on the privacy budget, determines a second variance for the second estimated value, and determines the estimated value for the aggregated metric by combining the first estimated value and the second estimated value according to the first variance and the second variance.

In some implementations, the first estimated value depends on a sum of the current cumulative count and a set of preceding cumulative counts, wherein each preceding cumulative count is determined based on the number of entity quantities that are equal to or greater than a value preceding the threshold value in the series of ascending values.

In some implementations, to determine the second estimated value, the system determines a set of updated entity-specific quantities by applying the updated threshold value to each of the entity-specific quantities, and determines the second estimated value based on the set of updated entity-specific quantities and the second noise value.

This specification also provides a system including one or more computers and one or more storage devices storing instructions that, when executed by the one or more computers, cause the one or more computers to perform the method described above.

This specification also provides one or more computer storage media storing instructions that when executed by one or more computers, cause the one or more computers to perform the method described above.

The subject matter described in this specification can be implemented in particular embodiments so as to realize one or more of the following advantages. Differential privacy is a family of privacy techniques that can be applied in various processes to protect privacy of individual entities. To apply differential privacy, noise is typically added to the computations or queries performed on a dataset. The added noise with appropriate noise level introduces randomness and obscures the contribution of specific individuals in the data while still revealing useful aggregate information. An important step in many differential privacy techniques is setting a clipping threshold which determines the maximum contribution any single data point can have to the final analysis. The noise level is then determined proportional to the clipping threshold. The threshold selection can have a great impact on the accuracy of the output generated from the data to which differential privacy has been applied. A threshold set too low truncates too many outliers and extreme values, leading to biased or incomplete results that may not accurately represent the underlying data distribution. A threshold set too high necessitates adding more noise to maintain privacy guarantees. This increased noise diminishes the accuracy and statistical power of the analysis.

Some differential privacy approaches rely on assumptions about the data distribution. These approaches may not generalize well to diverse datasets and can lead to suboptimal threshold choices. Some differential privacy approaches allocate a portion of the finite privacy budget to estimate the threshold, which inevitably leaves less budget for the core analysis, compromising its accuracy and statistical power.

The techniques described herein address the challenges associated with these differential privacy techniques by dynamically determining the optimal clipping threshold during the analysis. The described techniques leverage the concept of private cumulants, which are privacy-preserving statistical summaries of the data distribution. In particular, the described system iteratively calculates private cumulants, starting with lower-order cumulants and progressing to higher-order ones. The system can utilize these private cumulants to adaptively determine a suitable clipping threshold that minimizes information loss while simultaneously satisfying the privacy constraints imposed by the differential privacy framework. Once the optimal threshold is determined, the system can proceed with the intended analysis (e.g., calculating averages, sums, or other statistics), using the selected threshold for clipping and adding the appropriate amount of noise to guarantee differential privacy.

The threshold selection process described herein dynamically adjusts to the specific characteristics of the data, eliminating the need for potentially inaccurate prior assumptions or generic heuristics. The entire procedure, including threshold selection, can be conducted within the framework of differential privacy, ensuring strong privacy guarantees. By efficiently utilizing the privacy budget and adaptively choosing the optimal (or at least improved) threshold, the described techniques enhance the accuracy and statistical power of the final analysis compared to other methods. Efficiently utilizing a privacy budget enhanced user privacy by limiting the amount of data that can accessed while still enabling accurate analysis of aggregated data. The approach is also versatile and can be applied to a wide range of differentially private aggregation tasks.

The described technique contributes to improved computational efficiency in several ways. Firstly, the technique eliminates the need for multiple runs of the algorithm with different pre-defined thresholds, which would be computationally expensive. Secondly, by dynamically determining the optimal threshold, the technique can reduce the amount of noise required for privacy protection, leading to faster convergence and less computational overhead. Additionally, in some cases, the iterative calculation of private cumulants allows for early termination when sufficient information about the data distribution has been gathered, further reducing computational burden. Overall, the technique streamlines the process of differentially private aggregation, making it more efficient and scalable for larger datasets and complex analyses.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a digital component distribution system distributes digital components to client devices.

FIG. 2 is a flow diagram of an example process for estimating an aggregated metric characterizing a set of entities.

FIG. 3 shows the performances of example processes for estimating an aggregated metric characterizing a set of entities.

FIG. 4 is a block diagram of an example computer system.

FIG. 5 shows example pseudo-code for determining a threshold value and estimating the aggregated metric.

Like reference numbers and designations in the various drawings indicate like elements.

### DETAILED DESCRIPTION

In general, this specification describes systems and techniques for estimating, in a privacy-preserving manner, an aggregated metric characterizing a set of entities. While the focus of the following description centers around the distribution of digital components (e.g., videos, audio, digital images, computer games, text-based items, or data items), the process is used solely as an illustrative example to describe the provided techniques. The techniques described herein are applicable to other applications in which an aggregated metric is estimated in a privacy-preserving manner using differential privacy.

In particular, the system can be configured to estimate the aggregated metric based on data received from client devices. A digital component distribution system can use the estimated aggregated metric to adjust distribution parameters for distributing digital components to client devices in response to digital component requests.

Further to the descriptions throughout this document, a user may be provided with controls (e.g., user interface elements with which a user can interact) allowing the user to make an election as to both if and when systems, programs, or features described herein may enable the collection of user information (e.g., information about a user's social network, social actions, or activities, profession, a user's preferences, or a user's current location), and if the user is sent content or communications from a server.

In addition, certain data may be treated in one or more ways before it is stored or used, so that personally identifiable information is removed. For example, a user's identity may be treated so that no apparently personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and w % bat information is provided to the user.

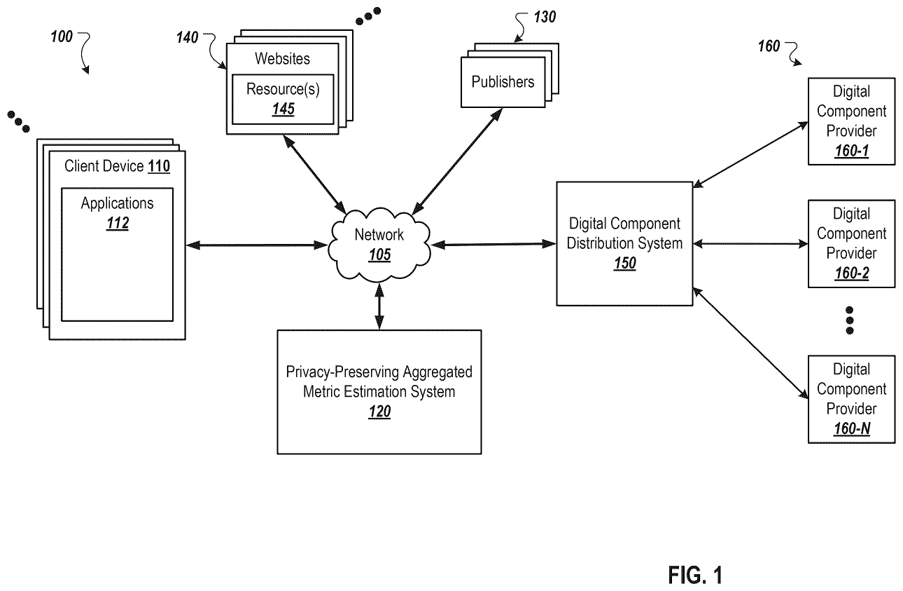

FIG. 1 is a block diagram of an example environment 100 in which a digital component distribution system 150 distributes digital components to client devices 110. The environment 100 includes a data communication network 105, such as a local area network (LAN), a wide area network (WAN), the Internet, a mobile network, or a combination thereof. The data communication network 105 connects client devices 110 and a privacy-preserving aggregated metric estimation system 120 to the digital component distribution system 150. The network 105 can also connect the digital component distribution system 150 to digital component providers, e.g., 160-1, 160-2, and 160-3.

A website 140 is one or more electronic resources 145 associated with a domain name and hosted by one or more servers. An example website is a collection of web pages formatted in HTML that can contain text, images, multimedia content, and programming elements, such as scripts. Each website 140 is maintained by a publisher 130, which is an entity that controls, manages and/or owns the website 140.

An electronic resource is also referred to herein as a resource for brevity. In this specification, resources can include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as scripts). A resource can be identified by a resource address, e.g., a Universal Resource Locator (URL) that is associated with the resource.

A client device 110 is an electronic device capable of requesting and receiving online resources over the network 105. Example client devices 110 include personal computers, gaming devices, mobile communication devices, digital assistant devices, augmented reality devices, virtual reality devices, and other devices that can send and receive data over the network 102. A client device can also include a digital media device, e.g., a streaming device that plugs into a television or other display to stream videos to the television.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

The client device 110 can include applications 112, such as web browsers and/or native applications, to facilitate the sending and receiving of data over the network 105. A native application is an application developed for a particular platform or a particular device (e.g., mobile devices having a particular operating system). Although operations may be described as being performed by the client device 110, such operations may be performed by an application 112 running on the client device 110.

The applications 112 can present electronic resources, e.g., web pages, application pages, or other application content, to a user of the client device 110. The electronic resources can include digital component slots for presenting digital components with the content of the electronic resources. A digital component slot is an area of an electronic resource (e.g., web page or application page) for displaying a digital component. A digital component slot can also refer to a portion of an audio and/or video stream (which is another example of an electronic resource) for playing a digital component.

As used throughout this specification, the “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include advertising information, such that an advertisement is a type of digital component. For example, the digital component may be content that is intended to supplement the content of a web page or other resource presented by the application 112. More specifically, the digital component may include digital content that is relevant to the resource content (e.g., the digital component may relate to the same topic as the web page content, or to a related topic). The provision of digital components can thus supplement, and generally enhance, the web page or application content.

When the application 112 loads a resource that includes a digital component slot, the application 112 can generate a digital component request that requests a digital component for display in the digital component slot. In some implementations, the digital component slot and/or the resource can include code (e.g., scripts) that cause the application 112 to request a digital component from the digital component distribution system 150.

A digital component request can include contextual data. The contextual data can be related to, e.g., describe, the environment in which a selected digital component will be presented. The contextual data can include, for example, coarse location information indicating a general location of the client device 110 that sent the digital component request, a resource (e.g., website or native application) with which the selected digital component will be presented (e.g., by including a resource locator such as a URI or URL for the resource), a spoken language setting of the application 112 or client device 110, the number of digital component slots in which digital components will be presented with the resource, the types of digital component slots, and/or other appropriate contextual information.

The privacy-preserving aggregated metric estimation system 120 is configured to receive, e.g., from the client devices 110, data characterizing interactions of a respective client device with a digital component, and aggregate the data for multiple client devices 110 to estimate an aggregated metric in a privacy-preserving manner. e.g., by applying differential privacy. For example, based on the received data, the system 120 can estimate an aggregated metric that quantifies a total number of accesses of the digital component by the set of client devices 110. Examples of accesses include a display or presentation of the digital component by a client device 110, or a delivery of the digital component to the client device 100. In another example, the system 120 can estimate an aggregated metric that quantifies a total number of actions taken by users of the set of client devices in response to accessing the digital component. Examples of the action include, e.g., interacting with (e.g., clicking on) a provided link (e.g., a link of the digital component), submitting a form, signing up for a newsletter, or downloading an application (e.g., mobile app).

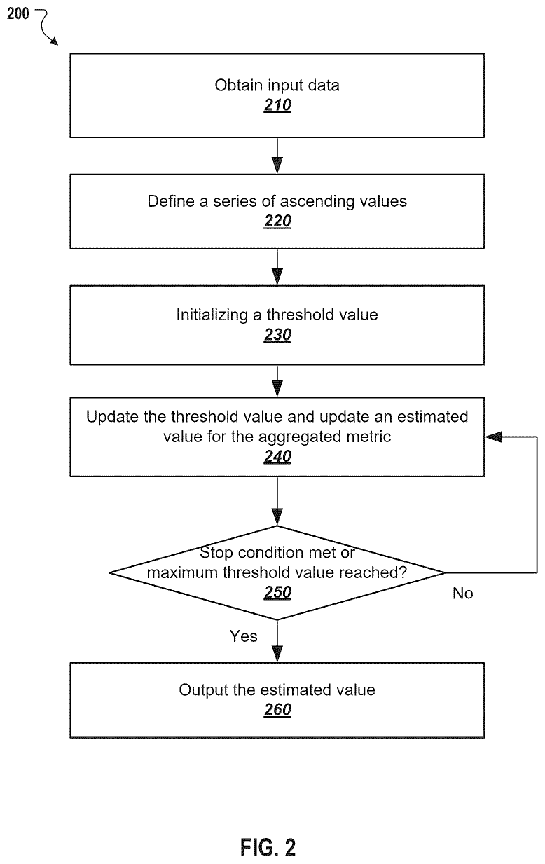

To ensure privacy while preserving the overall statistical properties and usefulness of the data, a threshold value for the individual data points often needs to be determined, so that an appropriate amount of noise can be introduced. The system 120 performs a process (as described below with reference to FIG. 2) to determine the threshold value that is part of the differential privacy process while updating the estimated value of the aggregated metric.

The digital component distribution system 150 can identify a set of digital components that are eligible to be presented to the client device 110 from among a corpus of digital components that are available from the content platform 150. For example, the digital component distribution system 150 can select one or more digital components from digital components stored in a digital component repository and/or a set of digital components received from digital component providers 160.

The digital component repository can store digital components received from the digital component providers and additional data (e.g., metadata) for each digital component in a database. The metadata for a digital component can include, for example, distribution criteria that define the situations in which the digital component is eligible to be provided to a client device 110 in response to a digital component request received from the client device 110 and/or a selection parameter that indicates an amount that will be provided to the publisher if the digital component is displayed with a resource of the publisher and/or interacted with by a user when presented. The distribution criteria and the selection parameter can be characterized by one or more distribution parameters.

For example, the distribution parameters for a particular digital component can include distribution keywords that must be matched, e.g., by terms specified in the request, in order for the digital component to be eligible for presentation. In another example, the distribution criteria for a digital component can include location information indicating which geographic locations that digital component is eligible to be presented, user group membership data identifying user groups to which the digital component is eligible to be presented, resource data identifying resources with which the electronic resource is eligible to be presented, and/or other appropriate distribution criteria. The distribution criteria can also include negative criteria, e.g., criteria indicating situations in which the digital component is not eligible (e.g., with particular resources or in particular locations). The distribution parameters can also specify a selection parameter and/or budget for distributing the particular third-party content.

The distribution parameters can be adjusted, e.g., by the digital component distribution system 150, based on the estimated value for the aggregated metric generated by the system 120. The digital component distribution system 150 can identify eligible digital components based on the distribution parameters and data included in the digital component request. The digital component distribution system 150 can then select a digital component from the eligible digital components and provide the selected digital component to the client device 110 for display to the user of the client device 110.

FIG. 2 is a flow diagram of an example process 200 for estimating an aggregated metric using differential privacy. Operations of the process 200 can be performed by a system of one or more computers located in one or more locations, such as a server. e.g., the aggregated metric estimation system 120 described with reference to FIG. 1, appropriately programmed in accordance with this specification. Operations of the process 200 can also be implemented as instructions stored on one or more computer-readable media, which may be non-transitory, and execution of the instructions by one or more data processing apparatus can cause the one or more data processing apparatus to perform the operations of the process 200. For convenience and without loss of generality, the process 200 will be described as being performed by a data processing apparatus, and in particular, a computer system.

At 210, the computer system obtains input data specifying, for each of the set of entities, an entity-specific quantity of the respective entity.

At 220, the computer system defines a series of ascending values representing possible values for the entity-specific quantities of the set of entities.

At 230, the computer system initializes a threshold value to a first value in the series of ascending values.

At 240, the computer system repeatedly performs operations for (i) updating the threshold value and (ii) updating an estimated value for the aggregated metric depending on the updated threshold value and a privacy budget until (i) the threshold value reaches a maximum threshold value or (ii) a stopping condition is met (at 250).

In general, the operations include updating the threshold value to a next value in the series of ascending values, determining a current cumulative count based on a number of entity-specific quantities equal or greater than the threshold value, determining the estimated value for the aggregated metric based at least on (i) the current cumulative count and (ii) a first noise value generated based the privacy budget, and determining whether the stopping condition is met based at least on the current cumulative count.

In some implementations, to determine whether the stopping condition is met, the system compares the current cumulative count to a predefined threshold count. If the current cumulative count is less than the predefined threshold count, the system determines that the stopping condition is met.

In some other implementations, the system determines whether the stopping condition is met based on a sum of the current cumulative count and one or more preceding cumulative counts. The system can determine each preceding cumulative count based on the number of entity quantities that are equal or greater than a value preceding the threshold value in the series of ascending values. The system can compare the sum to a predefined threshold count. If the sum is less than the predefined threshold count, the system determines that the stopping condition is met.

In some implementations, to determine the estimated value for the aggregated metric, the system determines a first estimated value based at least on the current cumulative count and the first noise value generated based on the privacy budget. The system also determines a first variance for the first estimated value, da second estimated value based at least on the updated threshold value and a second noise value generated based on the privacy budget, and a second variance for the second estimated value. The system determines the estimated value for the aggregated metric by combining the first estimated value and the second estimated value according to the first variance and the second variance.

In some implementations, the first estimated value depends on a sum of the current cumulative count and a set of preceding cumulative counts. Each preceding cumulative count can be determined based on the number of entity quantities that are equal to or greater than a value preceding the threshold value in the series of ascending values.

In some implementations, to determine the second estimated value, the system determines a set of updated entity-specific quantities by applying the updated threshold value to each of the entity-specific quantities, and determines the second estimated value based on the set of updated entity-specific quantities and the second noise value.

At 260, the system outputs the estimated value for the aggregated metric.

The operations of 220-250 are further described with the following analysis and implementation examples.

In a particular example, the input data specifies entity-specific quantities x₁, . . . , xₙ ϵ{0, 1, 2, . . . }. A goal is to estimate the sum Σᵢxᵢ while satisfying differential privacy. In order to compute such a sum privately, the system can determine a threshold T and project all data points to the interval [0, T]. The system can select this threshold adaptively as a function of the data while satisfying privacy without degrading the accuracy of the final (privacy-preserving) estimate.

Given a value T that is known to be an upper bound on every xᵢ, the system can privately estimate the sum by computing Σᵢxᵢ+Z, where Z is a random variable sampled from an appropriate distribution.

If Z˜Lap (T/ϵ) then this satisfies ϵ-DP, and if Z˜N(0, T²/(2ρ)) then this satisfies ρ-zCDP, which also implies a family of (ϵ, δ)-DP guarantees.

Even without an a priori bound, for any threshold T, the system can truncate larger values to T and compute the sum Σᵢ min(xᵢ, T)+Z. This truncation is sometimes referred to as thresholding, clipping, capping, or clamping.

As above, this satisfies differential privacy if Z is sampled from a Laplace or Gaussian distribution. As long as the sum is dominated by values below or near T, the truncated sum Σᵢ min(xᵢ, T) will be a good proxy for the original sum Σᵢxᵢ.

Care should be used to select a suitable threshold T. As T increases, the bias due to truncation decreases, but the variance of the added noise increases. Consequently choosing a threshold to minimize error metrics such as root mean square (RMS) error requires finding a good tradeoff between bias and variance. In some cases, it may be possible to set the threshold based on prior knowledge about the data distribution or historical data, if available. In other cases, it may be desirable to find or tune a good threshold based on the data itself. One way to do so would be to split the privacy budget and use one portion of the budget to compute a histogram, choosing a threshold based on the histogram that is used to approximate the sum with the remaining budget.

The techniques provided herein use a different approach for choosing a threshold based on the data itself without splitting the budget. As a building block, it will be useful to consider the problem of combining multiple estimates of the same value.

Suppose the system 120 obtains two estimates y₁ and y₂ of the sum Σᵢ min(xᵢ, T), with zCDP privacy budgets ρ₁ and ρ₂. That is, for kϵ{1, 2}, yₖ=Σᵢ min(xᵢ, T)+Zₖ, where Zₖ is sampled from a Gaussian distribution with variance vₖ=T²/2ρₖ.

Given separate estimates y₁ and y₂, the system can combine them into a single estimate

$$y = \frac{{v}_{2} {y}_{1} + {v}_{1} {y}_{2}}{{v}_{1} + {v}_{2}} .$$

This is the convex combination of y₁ and y₂ where each estimate is weighted inversely to its variance. The variance of this estimate is

$$\frac{{v}_{2}^{2} {v}_{1} + {v}_{1}^{2} {v}_{2}}{{( {v}_{1} + {v}_{2} )}^{2}} = \frac{{v}_{1} {v}_{2}}{{v}_{1} + {v}_{2}} = \frac{1}{1 / {v}_{1} + 1 / {v}_{2}} = \frac{{T}^{2}}{2 ( {ρ}_{1} + {ρ}_{2} )} .$$

Moreover, the exact distribution of the combined estimate y is given by y=Σᵢ min(xᵢ, T)+Z, where

$$Z ∼ N ( 0 , \frac{{T}^{2}}{2 ( {ρ}_{1} + {ρ}_{2} )} ) ,$$

and since it is a post-processing of a ρ₁−zCDP algorithm and a ρ₂-ZCP algorithm, estimating y, y₁ and y₂ together in this way satisfies (ρ₁+ρ₂)-zCDP. For comparison, directly estimating Σᵢ min(xᵢ, T) using the Gaussian mechanism with (ρ₁+ρ₂)-zCDP has exactly the same error distribution

$$N ( 0 , \frac{{T}^{2}}{2 ( {ρ}_{1} + {ρ}_{2} )} ) .$$

Similarly, combining k separate Gaussian mechanism estimates with privacy budgets ρ₁, ρ₂, . . . , ρₖ results in the same error distribution and the same zCDP guarantee as performing a single estimate with the total privacy budget ρ₁+ρ₂+ . . . +ρₖ. Thus, the Gaussian mechanism allows incremental estimation with partial budgets without any loss to overall accuracy.

Now returning to the operations of approximating the sum Σᵢxᵢ by choosing a good threshold T and estimating the sum Σᵢ min(xᵢ, T) with differential privacy. Given a (potentially loose) upper bound M on the values xᵢ, one way to do this is to compute the histogram hᵥ=|{i: xᵢ=v}| for each v ϵ{0, 1, . . . , M}. The system can release the entire histogram by adding noise N(0,1/(2ρ)) to each histogram bar, obtaining estimates h′ᵥ.

For each T≤M, the system can use these values to estimate the sum Σᵢ min(xᵢ, T) by computing

$${\sum }_{v = 1}^{M} v \cdot {h}_{v}^{′} .$$

Since v·h′ᵥ is distributed according to N(v·hᵥ, v²/2ρ), this estimate for the sum has error N(0, σ²) with

$${σ}^{2} = {\sum }_{v = 1}^{M} \frac{{v}^{2}}{2 ρ} + \frac{( M - T ) {T}^{2}}{2 ρ} = \frac{k ( k + 1 ) ( 2 k + 1 )}{12 ρ} + \frac{( M - T ) {T}^{2}}{2 ρ} \approx \frac{{k}^{3}}{6 ρ} + \frac{( M - T ) {T}^{2}}{2 ρ} .$$

Even assuming that the system has chosen a good threshold that upper bounds all values xᵢ, the resulting estimate

$${\sum }_{v = 1}^{T} v \cdot {h}_{v}^{′}$$

has variance

$${\sum }_{v = 1}^{M} \frac{{v}^{2}}{2 ρ} \approx \frac{{k}^{3}}{6 ρ} .$$

This estimate is \sqrt{k}/3 times worse than direct estimation with threshold T using the Gaussian mechanism, but additionally gives estimates for the full histogram and not just the sum.

Instead of computing the histogram directly, the system can compute a CDF formulation of the histogram.

For each v ϵ{1, . . . , M}, the system can estimate cᵥ=|{i: xᵢ≥v}|.

Since a single row in the database can influence each of these estimates, to achieve ρ-zCDP overall the system must add noise N(0, M/(2ρ)) to each estimate.

The sum Σᵢ min(xᵢ, M) is given by the sum

$${\sum }_{v = 1}^{M} {c}_{v}$$

of these values, so taking the sum of the estimates, the system obtains an estimate of the sum with error N(0, M²/(2ρ))—exactly the same error distribution as if the system had used the Gaussian mechanism directly to estimate the mean. This formulation gives not just an estimate of the sum with threshold M but also an estimate of the sum with any smaller threshold.

To estimate Σᵢ min(x_{i′}, T) for any T≤M, the system can simply compute

$${\sum }_{v = 1}^{T} {c}_{v} ,$$

taking the sum of only the first T values cᵥ instead of all M values. This gives an estimate for threshold T with error N(0, MT/(2ρ)) simultaneously for every threshold T. Although it is worse than the variance T²/(2ρ) estimate the system could have obtained if the system had chosen the threshold in advance, it still allows us to get a substantially lower variance than the variance from the original estimate M. In particular, the variance is the geometric mean of the variances T²/(2ρ) and M²/(2ρ) from directly using the Gaussian mechanism with thresholds T and M. and the standard deviation is the geometric mean of the two standard deviations.

In addition to simultaneously estimating the sum with different thresholds, the values cᵥ also give us more direct information about the distribution.

For example, the system can also obtain an estimate of the histogram by taking the difference between consecutive estimates cᵥ−cᵥ₊₁. This estimates each bar of the histogram with error N(0, M/ρ).

Like the estimates for the thresholds T≤M, the additional distributional information comes for free, since the estimate of the original sum is just as accurate as directly applying the Gaussian mechanism.

The above analysis demonstrates that privately estimating the cumulative histogram bins cᵥ={i: xᵢ≥v}| allows the system to estimate the sum

$${\sum }_{i} min ( {x}_{i} , T ) = {\sum }_{v = 1}^{T} {c}_{v}$$

for any threshold T≤M. Note that for threshold T the system only uses the estimates c₁, c₂, . . . , c_{T} and not estimates c_{T+1}, . . . , c_{M}.

Instead of computing all bin estimates c₁, . . . , c_{M} all at once, the system can compute c₁, c₂, . . . one by one, stopping at a bin c_{T} when this estimate (perhaps combined with previous estimates) indicates that T is a good threshold, for example, when c_{T}≈0. As before, this allows the system to estimate

$${y}_{1} = {\sum }_{i} min ( {x}_{i} , T ) = {\sum }_{v = 1}^{T} {c}_{v}$$

with variance v₁=MT/(2ρ).

However, since the system has only estimated c₁, . . . , c_{T} and not c_{T+1}, . . . , c_{M}, the system has only used a zCDP privacy budget of Tρ/M of the total privacy budget of ρ, and has a remaining privacy budget of

$$\frac{( M - T ) ρ}{M}$$

that can still be used.

The system can use this budget to obtain a separate estimate y₂=Σᵢ min(xᵢ, T)+N(0, T²M/(2(M−T)ρ)) of variance

$${v}_{2} = \frac{{T}^{2} M}{2 ( M - T ) ρ} ,$$

where the system has estimated both y₁ and y₂ with ρ-zCDP.

Taking the convex combination

$$y = \frac{{v}_{2} {y}_{1} + {v}_{1} {y}_{2}}{{v}_{1} + {v}_{2}} ,$$

the system can obtain a single estimate with variance

$$\frac{1}{1 / {v}_{1} + 1 / {v}_{2}} = \frac{1}{2 ρ / ( MT ) + 2 ( M - T ) ρ / ( {T}^{2} M )} = \frac{{T}^{2}}{2 ρ ( T / M + ( M - T ) / M )} = \frac{{T}^{2}}{2 ρ} ,$$

so this estimate has the same variance (and the exact same noise distribution N(0, T²/(2ρ))) as if the system had chosen threshold T to begin with and estimated the truncated sum using the Gaussian mechanism.

Consequently, as long as this adaptive approach is able to select a good threshold T, it obtains just as good accuracy as if the system had a defined threshold in advance.

It remains to specify a condition for when to stop-that is, for which iteration will be the final one, determining the threshold T. Many stopping conditions are reasonable, based either on the value of the last bin c_{T} or based on the values of all previous bins c₁, . . . , c_{T}.

A few conditions that the system can use for determining whether to stop at iteration v are:

Stop if cᵥ≤τ for some threshold τ.

Stop if v≡0(mod k) and cᵥ₋ₖ₊₁+cᵥ₋ₖ₊₂+ . . . +cᵥ≤τ for some threshold τ. Stop if v≥k and cᵥ₋ₖ₊₁+cᵥ₋ₖ₊₂+ . . . +cᵥ+τ for some threshold τ

That is, the system can stop based on the value of the final bin cᵥ, or the system can test every bin based on the sum of the previous k, or the system can use a sliding window approach based on the sum of the previous k bins.

Based on preliminary experiments on the data, all three conditions give some improvement, but the second and third conditions appear to perform better on this dataset with parameters k=10 and k=15, respectively.

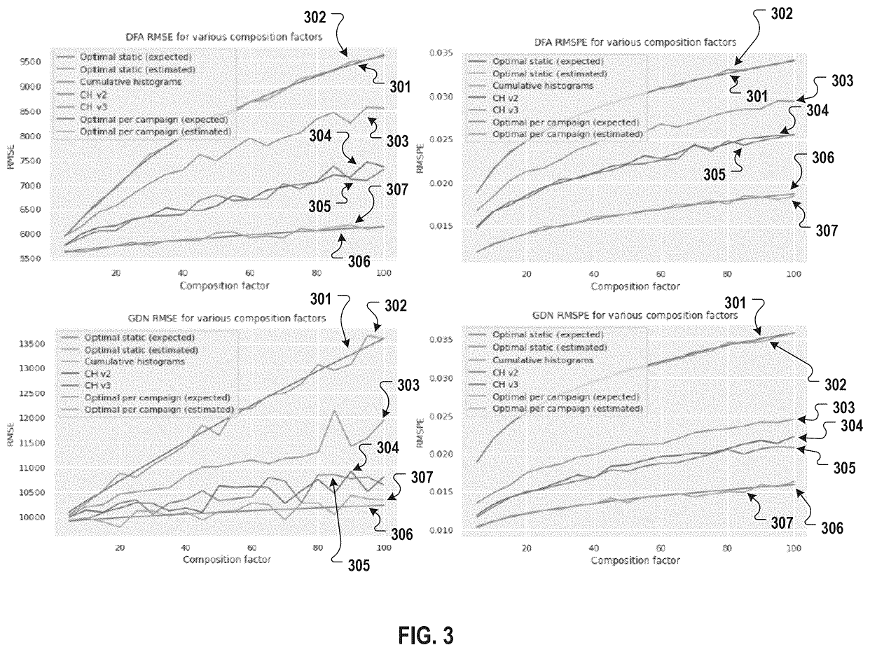

FIG. 3 shows experimental evaluations of example processes described above based on two datasets. In the plots: The first line 301 and the second line 302 give the baseline error of the best single threshold applied to all data. The third line 303, fourth line 304, and fifth line 305 give the error of the differential privacy techniques described above with three different stopping conditions. The sixth line 306 and the seventh line 307 give the optimistic, best-possible error when using the optimal threshold for each choice of a campaign. This is a lower bound on the error the system can achieve with thresholding and the Gaussian mechanism.

The total privacy budget is (ϵ, δ)=(1, 10⁻⁷), which is implied by ρ-zCDP with ρ≈0.02284. This privacy budget is divided among between 5 and 100 simulated queries, as depicted on the x-axis, where the estimation of the total number of impressions is one of these queries.

The error metrics plotted are root mean squared error

$$RMS = \sqrt{\frac{1}{k} {\sum }_{i = 1}^{k} [ {( {x}_{i} - {\hat{x}}_{i} )}^{2}}$$

and root mean squared percent error

$$RMSPE = \sqrt{\frac{1}{k} {\sum }_{i = 1}^{k} \frac{{( {x}_{i} - {\hat{x}}_{i} )}^{2}}{{x}_{i}^{2}}}$$

where x₁, . . . , xₖ and \hat{x}₁, . . . , \hat{x}ₖ are the true and estimated number of impressions for each campaign. Each point on the plot is the median error from 9 executions of the algorithm (except for the blue and brown lines, which are plotted based on the expected value of the error).

For the set of plots, the system uses optimal PLD composition (or, equivalently, zCDP composition) to divide the privacy budget among the 5-100 simulated queries. The system uses a maximum threshold of M=200.

The stopping conditions used in these plots include the following:

$$v 1 : c [ k ] \leq - 1.5 sqrt ( M / ( 2 ρ ) )$$

$$v 2 : k mod 10 == 0 and$$

$$c [ k - 9 ] + c [ k - 8 ] + … + c [ k ] \leq sqrt ( 5 / 2 ) * sqrt ( M / 2 ρ ) )$$

$$v 3 : k \geq 15 and c [ k - 14 ] + c [ k - 13 ] + … + c [ k ] \leq 2 sqrt ( M / ( 2 ρ ) )$$

These thresholds were selected to achieve good performance on the first dataset, and the same thresholds were used on the other dataset. Similar performance on the two datasets are shown (even though hyperparameters were tuned on only the first).

The stopping condition parameters are hand-tuned, and it is likely that better performance can be achieved with either automated tuning over the parameter space or a principled derivation. The ideal stopping condition for minimizing RMSE appears to be different from the ideal stopping condition for minimizing RMSPE. The stopping conditions used in this experiment were chosen to have reasonable performance simultaneously for both metrics and a range of privacy parameters; optimizing for a single error metric and privacy parameter would almost certainly improve performance in that setting. Note also that the optimal threshold can be estimated using only a sample of the data, without access to the full dataset.

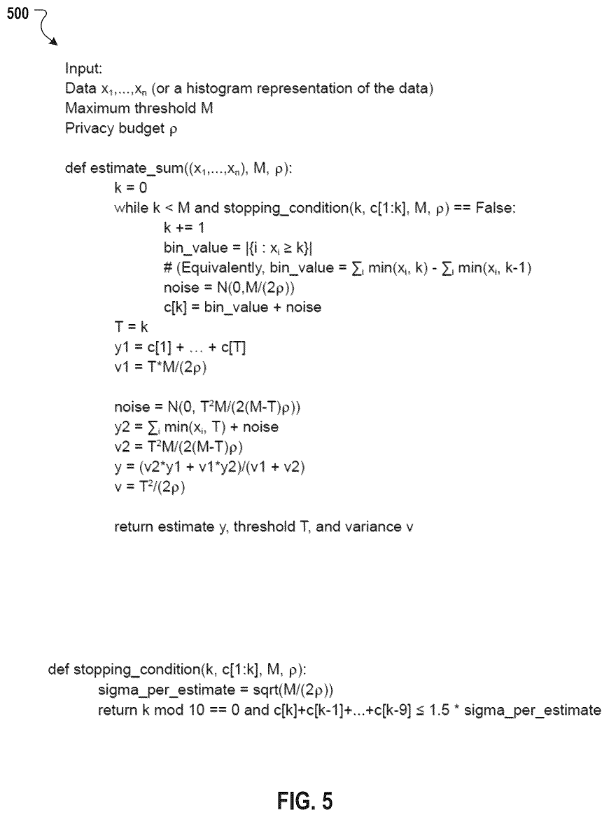

FIG. 5 shows example pseudo-code 500 for determining the threshold value and estimating the aggregated metric.

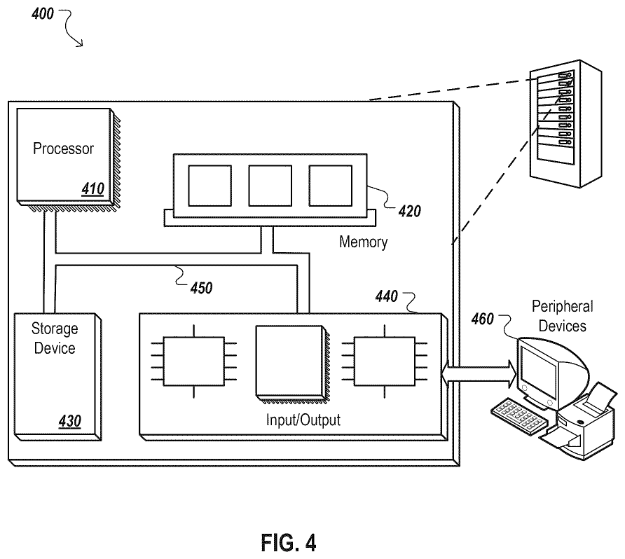

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city. ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for estimating, in a privacy-persevering manner, an aggregated metric characterizing a set of entities, the method comprising:
obtaining input data specifying, for each of the set of entities, an entity-specific quantity of the respective entity;
defining a series of ascending values representing possible values for the entity-specific quantities of the set of entities;
initializing a threshold value to a first value in the series of ascending values;
repeatedly performing operations for (i) updating the threshold value and (ii) updating an estimated value for the aggregated metric depending on the updated threshold value and a privacy budget, until (i) the threshold value reaches a maximum threshold value or (ii) a stopping condition is met, the operations comprising:
updating the threshold value to a next value in the series of ascending values;
determining a current cumulative count based on a number of entity-specific quantities equal to or greater than the threshold value;
determining the estimated value for the aggregated metric based at least on (i) the current cumulative count and (ii) a first noise value generated based on the privacy budget; and
determining whether the stopping condition is met based at least on the current cumulative count; and
outputting the estimated value for the aggregated metric.

2. The method of claim 1, wherein:
the set of entities comprise a set of client devices;
each entity-specific quantity characterizes an interaction of a respective client device with a digital component; and
the method further comprises:
adjusting, based at least on the estimated value of the aggregated metric, one or more distribution parameters for distributing digital components to client devices in response to digital component requests; and
distributing digital components to the client devices based on the distribution parameters.

3. The method of claim 2, wherein each entity-specific quantity specifies a number of times that a respective client device has accessed a digital component; and
the aggregated metric quantifies a total number of accesses of the digital component by the set of client devices.

4. The method of claim 2, wherein each entity-specific quantity specifies a number of times that a respective client device has taken a particular action in response to accessing a digital component; and
the aggregated metric quantifies a total number of actions taken by the set of client devices in response to accessing the digital component.

5. The method of claim 1, wherein determining whether the stopping condition is met comprises:
comparing the current cumulative count to a predefined threshold count; and
in response to the current cumulative count being below the predefined threshold count, determining that the stopping condition is met.

6. The method of claim 1, wherein determining whether the stopping condition is met comprises:
computing a sum of the current cumulative count and one or more preceding cumulative counts, wherein each preceding cumulative count is determined based on the number of entity quantities that are equal or greater than a value preceding the threshold value in the series of ascending values;
comparing the sum to a predefined threshold count; and
in response to the sum being below the predefined threshold count, determining that the stopping condition is met.

7. The method of claim 1, wherein determining the estimated value for the aggregated metric comprises:
determining a first estimated value based at least on (i) the current cumulative count and (ii) the first noise value generated based on the privacy budget;
determining a first variance for the first estimated value;
determining a second estimated value based at least on (i) the updated threshold value and (ii) a second noise value generated based on the privacy budget;
determining a second variance for the second estimated value; and
determining the estimated value for the aggregated metric by combining the first estimated value and the second estimated value according to the first variance and the second variance.

8. The method of claim 7, wherein the first estimated value depends on a sum of the current cumulative count and a set of preceding cumulative counts, wherein each preceding cumulative count is determined based on the number of entity quantities that are equal or greater than a value preceding the threshold value in the series of ascending values.

9. The method of claim 7, wherein determining the second estimated value comprises:
determining a set of updated entity-specific quantities by applying the updated threshold value to each of the entity-specific quantities; and
determining the second estimated value based on the set of updated entity-specific quantities and the second noise value.

10. (canceled)

11. One or more non-transitory computer-readable storage media storing instructions that, when executed by one or more computers, cause the one or more computers to perform operations comprising:
obtaining input data specifying, for each of the set of entities, an entity-specific quantity of the respective entity;
defining a series of ascending values representing possible values for the entity-specific quantities of the set of entities;
initializing a threshold value to a first value in the series of ascending values;
repeatedly performing operations for (i) updating the threshold value and (ii) updating an estimated value for the aggregated metric depending on the updated threshold value and a privacy budget, until (i) the threshold value reaches a maximum threshold value or (ii) a stopping condition is met, the operations comprising:
updating the threshold value to a next value in the series of ascending values;
determining a current cumulative count based on a number of entity-specific quantities equal to or greater than the threshold value;
determining the estimated value for the aggregated metric based at least on (i) the current cumulative count and (ii) a first noise value generated based on the privacy budget; and
determining whether the stopping condition is met based at least on the current cumulative count; and
outputting the estimated value for the aggregated metric.

12. The one or more non-transitory computer-readable storage media of claim 11, wherein:
the set of entities comprise a set of client devices;
each entity-specific quantity characterizes an interaction of a respective client device with a digital component; and
the instructions cause the one or more computers to perform operations further comprising:
adjusting, based at least on the estimated value of the aggregated metric, one or more distribution parameters for distributing digital components to client devices in response to digital component requests; and
distributing digital components to the client devices based on the distribution parameters.

13. The one or more non-transitory computer-readable storage media of claim 12, wherein each entity-specific quantity specifies a number of times that a respective client device has accessed a digital component; and
the aggregated metric quantifies a total number of accesses of the digital component by the set of client devices.

14. The one or more non-transitory computer-readable storage media of claim 12, wherein each entity-specific quantity specifies a number of times that a respective client device has taken a particular action in response to accessing a digital component; and
the aggregated metric quantifies a total number of actions taken by the set of client devices in response to accessing the digital component.

15. The one or more non-transitory computer-readable storage media of claim 11, wherein determining whether the stopping condition is met comprises:
comparing the current cumulative count to a predefined threshold count; and
in response to the current cumulative count being below the predefined threshold count, determining that the stopping condition is met.

16. The one or more non-transitory computer-readable storage media of claim 11, wherein determining whether the stopping condition is met comprises:
computing a sum of the current cumulative count and one or more preceding cumulative counts, wherein each preceding cumulative count is determined based on the number of entity quantities that are equal or greater than a value preceding the threshold value in the series of ascending values;
comparing the sum to a predefined threshold count; and
in response to the sum being below the predefined threshold count, determining that the stopping condition is met.

17. The one or more non-transitory computer-readable storage media of claim 11, wherein determining the estimated value for the aggregated metric comprises:
determining a first estimated value based at least on (i) the current cumulative count and (ii) the first noise value generated based on the privacy budget;
determining a first variance for the first estimated value;
determining a second estimated value based at least on (i) the updated threshold value and (ii) a second noise value generated based on the privacy budget;
determining a second variance for the second estimated value; and
determining the estimated value for the aggregated metric by combining the first estimated value and the second estimated value according to the first variance and the second variance.

18. A system comprising:
one or more computers; and
one or more storage devices storing instructions that when executed by the one or more computers, cause the one or more computers to perform operations comprising:
obtaining input data specifying, for each of the set of entities, an entity-specific quantity of the respective entity;
defining a series of ascending values representing possible values for the entity-specific quantities of the set of entities;
initializing a threshold value to a first value in the series of ascending values;
repeatedly performing operations for (i) updating the threshold value and (ii) updating an estimated value for the aggregated metric depending on the updated threshold value and a privacy budget, until (i) the threshold value reaches a maximum threshold value or (ii) a stopping condition is met, the operations comprising:
updating the threshold value to a next value in the series of ascending values;
determining a current cumulative count based on a number of entity-specific quantities equal to or greater than the threshold value;
determining the estimated value for the aggregated metric based at least on (i) the current cumulative count and (ii) a first noise value generated based on the privacy budget; and
determining whether the stopping condition is met based at least on the current cumulative count; and
outputting the estimated value for the aggregated metric.

19. The system of claim 18, wherein:
the set of entities comprise a set of client devices;
each entity-specific quantity characterizes an interaction of a respective client device with a digital component; and
the instructions cause the one or more computers to perform operations further comprising:
adjusting, based at least on the estimated value of the aggregated metric, one or more distribution parameters for distributing digital components to client devices in response to digital component requests; and
distributing digital components to the client devices based on the distribution parameters.

20. The system of claim 19, wherein each entity-specific quantity specifies a number of times that a respective client device has accessed a digital component; and
the aggregated metric quantifies a total number of accesses of the digital component by the set of client devices.

21. The system of claim 19, wherein each entity-specific quantity specifies a number of times that a respective client device has taken a particular action in response to accessing a digital component; and
the aggregated metric quantifies a total number of actions taken by the set of client devices in response to accessing the digital component.
